(19) United States
(12) Patent Application Publication
(10) Pub. No.: US 2003/0088799 A1
(43) Pub. Date: May 8, 2003

(54) Method and apparatus for regulation of electrical component temperature and power consumption rate through bus width reconfiguration

(76) Inventor: Devadatta V. Bodas, Federal Way, WA (US)

Correspondence Address: KENYON & KENYON, Suite 600, 333 W. San Carlos Street, San Jose, CA, 95110-2711, US

(21) Appl. No.: 10/010,395

(22) Filed: Nov. 5, 2001

(51) Int. Cl. G06F 1/26; G06F 1/32

(52) U.S. Cl. 713/320

(57) ABSTRACT

A system is disclosed for the regulation of electrical component temperature and power consumption rate through the reconfiguration between different interconnect bus widths.

### BACKGROUND INFORMATION

The present invention relates to electrical system management. More specifically, the present invention relates to the regulation of electrical component temperature and power consumption rate through the reconfiguration between different interconnect bus widths.

Interconnect bus technology is continually driving towards higher-speed serial bus utilization. Along with increased communication rates comes higher power consumption and heat production. In many systems today, temperature regulation of high-power processors, such as central processing units (CPU), involves the usage of electric fan(s). Often, a system has its own thermally segregated cooling zone incorporating routed ventilation ducts. For the other components in such a system, other system fan(s) are utilized to cool the memory, input/output (I/O) adapters, and chipset components.

With faster, denser memory, high-speed I/O devices, and chipsets with high-speed interconnects, temperature regulation becomes an even more challenging problem. Typically, a larger diameter fan or fan with higher rotational speed is used to compensate for the additional heat production. However, such solutions result in higher acoustic noise (in addition to possible electromagnetic interference), making the system unfit for many environments and may not be feasible due to dimensional constraints. Further, cooling fans can consume a considerable amount of valuable system power.

FIG. 1 illustrates the layout of a typical computer memory system utilizing an electric fan for temperature reduction. A continuously-operating fan blows cool air towards and across computer component(s), such as memory 104 and/or a memory controller 106 (as shown). Or, in another configuration in the art, a fan draws hot air from the component(s), sending it out of the computer enclosure (not shown). As stated above, an electric fan 102, such as is typical in the art produces a large amount of undesirable noise, and because of frictional losses incurred by the moving parts, fan operation consumes a great deal of valuable system energy.

It is therefore desirable to have a system for temperature regulation of electronic components that avoids the above-mentioned problems, in addition to having other advantages, such as improved control over power consumption rate.

### BRIEF DESCRIPTION OF THE DRAWINGS

FIG. 1 illustrates the layout of a typical computer memory system utilizing an electric fan for temperature reduction.

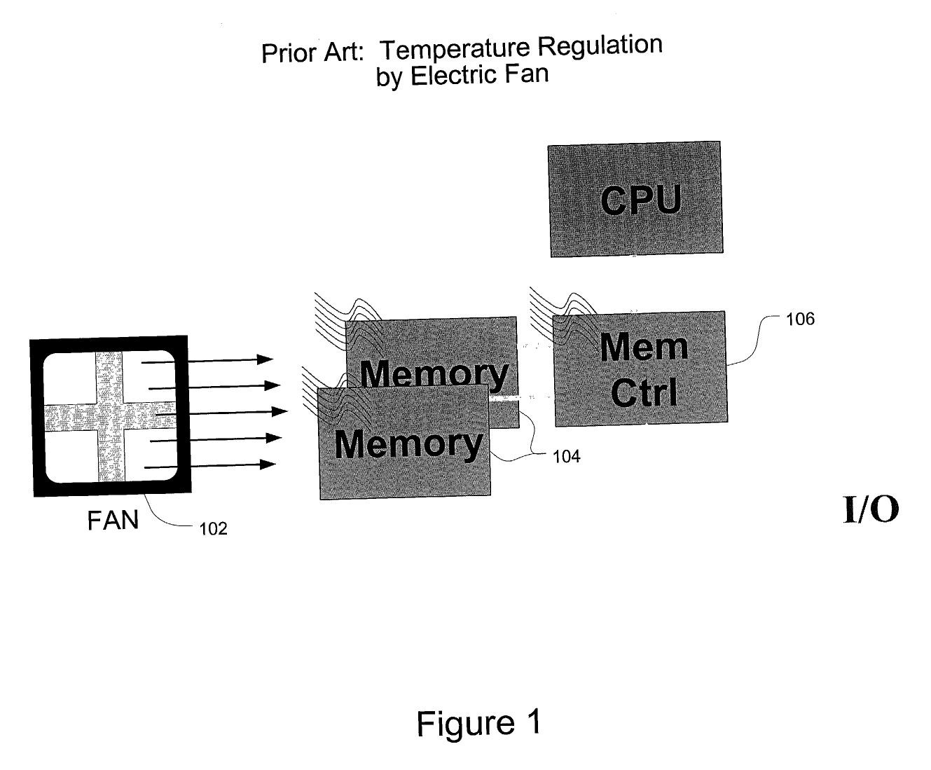

FIG. 2 provides a block diagram illustration of a power and temperature regulation device utilizing interface bus width control under principles of the present invention.

FIG. 3 provides an illustration of the process of power/thermal management under principles of the present invention.

### DETAILED DESCRIPTION

As computer performance improves through increased component speed, thermal energy production increases as well. An embodiment of the present invention provides for a method to balance computer performance with chip environmental needs.

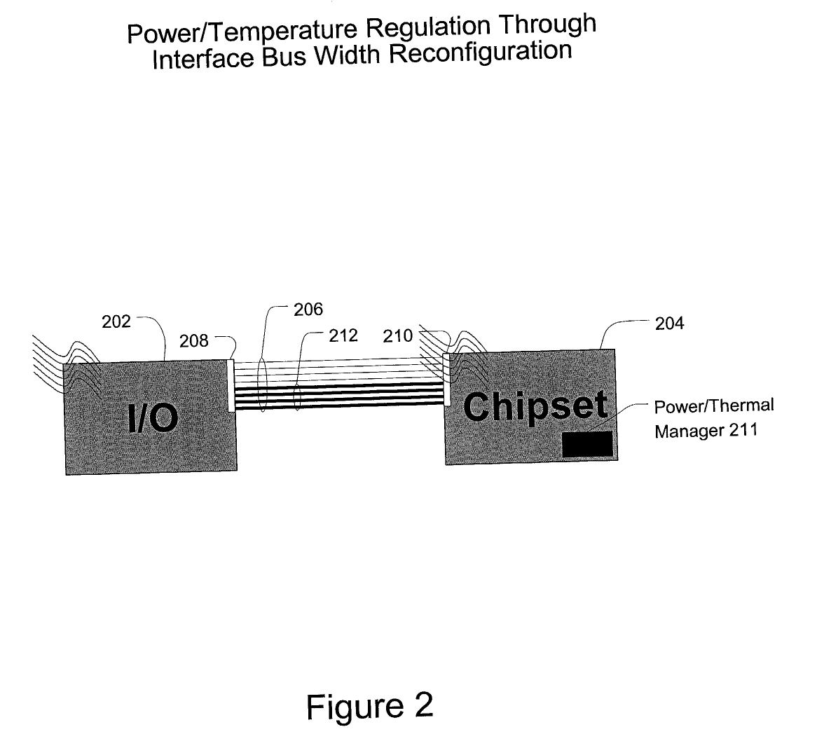

FIG. 2 provides a block diagram illustration of a power and temperature regulation device utilizing interface bus width control under principles of the present invention. In one embodiment, an interface 206 between a chipset 204 and an Input/Output (I/O) controller 202 exists. In accessing I/O 202, the chipset 204 in one embodiment utilizes an 8-bit wide serial high-speed interconnect link 206 interface and consumes approximately 2 watts of power per port 208,210. If both sides, initiator (202/204) and target (204/202), of an interconnect link 206 reside inside one system, such as is shown in FIG. 2, 4 watts of power per 8-bit link 206 are consumed.

In one embodiment, the bus width, representative of the number of communication lines (channels) utilized by the bus, is reconfigurable to different sizes (e.g. 2-bit, 4-bit, 8-bit, etc.). In one embodiment, this reconfiguration can be performed utilizing such buffering methods as are well known in the art, e.g. internal timing logic used to control an interface between I/O buffers (not shown) and the chip's 204 internal bus. FIG. 2 demonstrates an 8-bit bus (interconnect link) 206, which is currently utilizing only 4 of the lines (4-bit) 212 to reduce heat production and/or to reduce the rate of energy consumption. In one embodiment, the bus width is reconfigurable during system operation after ‘reset’ or ‘power-on’ (in addition to at ‘start-up’). In one embodiment, reconfiguration can be performed by various methods known in the art. Reconfiguration may be instigated by either an initiator (202/204) or a target (204/202) by sending a special command (or request). In one embodiment, the initiator (202/204) and target (204/202) may then go through a ‘reset’ process to change the bus width. In the alternative, the initiator (202/204) and target (204/202) may change the bus width following a specific handshake process.

In one embodiment, a power/thermal manager 211 initiates and executes reconfiguration under Operating System-directed configuration Power Management (OSPM). OSPM is a general term used by ACPI (Advanced Configuration and Power Interface), an industry standard established by Intel, Microsoft, and Toshiba (ACPI 1.0b specification, February 1999). ACPI is an open specification that encompasses PC hardware, operating system software and peripheral device interfaces. The specification provides the manner in which the Operating System (OS), motherboard hardware, and peripheral devices (such as CD-ROMs, hard drives, etc.) talk to each other regarding power usage. (See http://www.intel.com/eBusiness/products/mobile/initiatives/ar420.htm) Operating System Directed Power Management (OSPM) involves the OS managing all power activities and providing power to devices only on an ‘as-needed’ basis.

In an embodiment of the present invention, a ‘power event’ (triggering event) triggers the power manager 211 to request a change in power consumption of an interconnect link(s) 206 by reconfiguring to a different number of utilized lines 212 in the bus(es) 206. For example, a system may have a north bridge, such as a memory controller hub (MCH), connected to two I/O bridges (IOH), each with 8-bit high-speed serial links. Such an interconnect mechanism may consume about 8 watts of system power. In one embodiment, an OSPM request to reduce to a 4 bit link may result in a reduction of power consumption to 4 watts, saving about 4 watts of power (or 50%).

In one embodiment, various situations can constitute a ‘power event’ for triggering bus width reconfiguration. These include: (1) Temperature increase inside the system beyond some threshold; (2) Failure of a system fan(s); (3) Increase in die temperature of a chipset component(s); (4) System requirement for operation under battery power due to failure of an Alternating Current (AC) source, etc. (bus width reduction to decrease power consumption rate); and (5) Consistently low system utilization.

This system of power/thermal regulation is also envisioned as being utilized for interface between a processor, such as a central processing unit (CPU), and a chipset (memory controller). Further, in an another alternative embodiment, the system could be used for interface between a chipset and memory, between two processors (such as CPU's) or between two I/O devices.

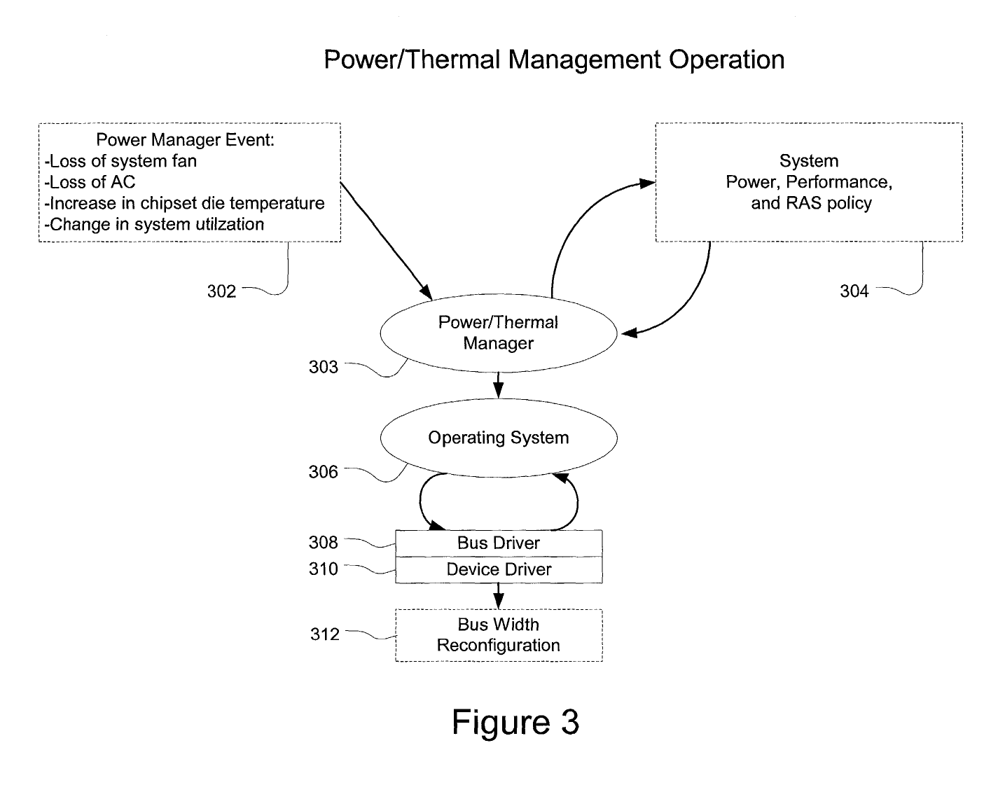

FIG. 3 provides an illustration of the process of power/thermal management under principles of the present invention. In one embodiment, a ‘power event’ 302 is communicated to a power manager 303. The power manager 303 implements a policy-based decision 304, the policy being for management of system power, temperature regulation, performance, and ‘Reliability, Availability, and Serviceability’ (RAS) concerns. Based on policy, the power manager 303 may request a change of interconnect bus width of one or more system components. In an embodiment, the operating system 306 communicates with the bus and device drivers 308,310 to request a change of power state (bus width). In an embodiment, the bus and device drivers 308,310 take preparatory action and then indicate when ready for such a transition. When appropriate, the operating system 306 requests the bus width reconfiguration 312.

In one embodiment, if the customer environment is cool, the system remains configured for high performance (high speed). A system does not need to be designed for the ‘worst case scenario’ (to the detriment of all system users in more temperate environments). The system can be designed for ‘normal’ (average) operating conditions and environments, and if the conditions are worse than this, the system, under principles of the present invention, will reconfigure itself. In an embodiment, the system can reconfigure itself as many times as necessary after boot-up, following environmental changes.

Although several embodiments are specifically illustrated and described herein, it will be appreciated that modifications and variations of the present invention are covered by the above teachings and within the purview of the appended claims without departing from the spirit and intended scope of the invention.

1. A system to control a communication rate between electrical components, comprising:
a first component including a first port to be coupled to a first number of communication channels, said first port to control communication between the first port and the communication channels at a first communication rate, such that said first port is to communicate with a second number of communication channels in response to triggering event, said number being less than said first number.

2. The system of claim 1, wherein a reconfiguration is performed by a power manager to change from communication with the first number of channels to the second number of channels.

3. The system of claim 1, wherein a reconfiguration is performed by a thermal manager to change from communication with the first number of channels to the second number of channels.

4. The system of claim 1, wherein a reconfiguration is performed by an opera ting system under Operating System-based Power Management (OSPM) to change from communication with the first number of channels to the second number of channels.

5. The system of claim 1, wherein said first number of channels includes said second number of channels as a subset.

6. The system of claim 5, wherein an Interconnect bus includes said first number of communication channels.

7. The system of claim 1, wherein a reconfiguration is performed to change from communication with the first number of channels to the second number of channels in response to said triggering event as a system management policy-based decision.

8. The system of claim 7, wherein said policy-based decision involves analysis of a number of decision criteria.

9. The system of claim 8, wherein said number of decision parameters include: Power Management; Thermal Management; Reliability, Availability, and Serviceability (RAS); and System Performance.

10. The system of claim 8, wherein said analysis and said reconfiguration occur at a time after system boot-up.

11. A method to control the communication rate of electrical components comprising:
utilizing, by a first component, a first number of communication channels to communicate with a second component at a first communication rate;
utilizing, by said first component, a second number of communication channels to communicate with said second component at a second communication rate; and
reconfiguring between the utilization of said first number of channels and said second number of channels in response to a triggering event.

12. The method of claim 11, wherein said reconfiguration is performed by a power manager.

13. The method of claim 11, wherein said reconfiguration is performed by a thermal manager.

14. The method of claim 11, wherein said reconfiguration is performed by an operating system under Operating System based Power Management (OSPM).

15. The method of claim 11, wherein said first number of channels includes said second number of channels as a subset.

16. The method of claim 15, wherein an Interconnect bus includes said first number of communication channels.

17. The method of claim 11, wherein said reconfiguration is performed in response to said triggering event as a system management policy-based decision.

18. The method of claim 17, wherein said policy-based decision involves analysis of a number of decision criteria.

19. The method of claim 18, wherein said number of decision parameters include: Power Management; Thermal Management; Reliability, Availability, and Serviceability (RAS); and System Performance.

20. The method of claim 18, wherein said analysis and said reconfiguration occur at a time after system boot-up.

21. A set of instructions residing in a storage medium, said set of instructions capable of being executed by a processor to control the communication rate of electrical components comprising:
utilizing, by a first component, a first number of communication channels to communicate with a second component at a first communication rate;
utilizing, by said first component, a second number of communication channels to communicate with said second component at a second communication rate; and
reconfiguring between the utilization of said first number of channels and said second number of channels in response to a triggering event.

22. The set of instructions of claim 21, wherein said reconfiguration is performed by a power manager.

23. The set of instructions of claim 21, wherein said reconfiguration is performed by a thermal manager.

24. The set of instructions of claim 21, wherein said reconfiguration is performed by an operating system under Operating System based Power Management (OSPM).

25. The set of instructions of claim 21, wherein said first number of channels includes said second number of channels as a subset.

26. The set of instructions of claim 25, wherein an Interconnect bus includes said first number of communication channels.

27. The set of instructions of claim 21, wherein said reconfiguration is performed in response to said triggering event as a system management policy-based decision.

28. The set of instructions of claim 27, wherein said policy-based decision involves analysis of a number of decision criteria.

29. The set of instructions of claim 28, wherein said number of decision parameters include: Power Management; Thermal Management; Reliability, Availability, and Serviceability (RAS); and System Performance.

30. The set of instructions of claim 28, wherein said analysis and said reconfiguration occur at a time after system boot-up.
